(19) United States
(12) Patent Application Publication
(10) Pub. No.: US 2026/0027658 A1
(43) Pub. Date: Jan. 29, 2026

(54) SYSTEM AND METHODS FOR LABELING CONFECTIONARY PRODUCTS WITH LASER-ETCHING

(71) Applicant: Mars, Incorporated, McLean, VA (US)

(72) Inventors: Richard AMMENDOLA, Naperville, IL (US); Peter KASHULINES, McLean, VA (US); Frank MESHACH, McLean, VA (US)

(21) Appl. No.: 18/781,384

(22) Filed: Jul. 23, 2024

(51) Int. Cl. B23K 26/362; A23G 7/00; B23K 26/067; B23K 26/08; B23K 26/082; B23K 26/16

(52) U.S. Cl. CPC B23K 26/362; B23K 26/0676; B23K 26/082; B23K 26/0838; B23K 26/16; A23G 7/005

(57) ABSTRACT

A system may include a conveyor system with a transport path that transports the plurality of objects from a first end to a second end, the conveyor system rotating about a first axis in a transporting direction. A system may include a laser system configured to interact with the plurality of objects while the plurality of objects are on the transport path between the first end and the second end, the laser system including a laser source that emits a laser beam, one or more beam splitters configured to split the laser beam into a plurality of beam segments, and one or more beam deflectors configured to direct each beam segment of the plurality of beam segments onto an outer surface of the plurality of objects such that each beam segment is configured to laser-etch the outer surface of the plurality of objects.

### TECHNICAL FIELD

This disclosure generally relates to laser-etching confectionary products.

### BACKGROUND

Etching techniques are often used during the manufacturing or production of confectionary products. In particular, etching techniques can be used to create various prints or designs on the confectionary products. One such etching technique can involve the use of laser-etching. Laser-etching uses laser energy to target, ablate, and remove at least part of a substrate included in a given confectionary product. Laser-etching techniques involve complex systems and devices to properly supply an adequate laser to the confectionary products. Often, confectionary products must be rapidly produced, which can cause issues since laser-etching can be a time consuming process. The laser system must be capable of laser-etching a large quantity of product within a short amount of time. Accordingly, there is an ongoing need for a system or method to laser-etch products in a timely manner.

### SUMMARY

In some aspects, the techniques described herein relate to a system for laser-etching a plurality of objects, the system including: a conveyor system with a transport path that transports the plurality of objects from a first end to a second end, the conveyor system rotating about a first axis in a transporting direction; and a laser system configured to interact with the plurality of objects while the plurality of objects are on the transport path between the first end and the second end, the laser system including: a laser source, the laser source emitting a laser beam; one or more beam splitters configured to split the laser beam into a plurality of beam segments; and one or more beam deflectors configured to direct each beam segment of the plurality of beam segments onto an outer surface of the plurality of objects, wherein each beam segment is configured to laser-etch the outer surface of the plurality of objects.

In some aspects, the techniques described herein relate to a system, the laser system is within a housing, and wherein the one or more beam deflectors deflect the plurality of beam segments through one or more laser windows above the transport path.

In some aspects, the techniques described herein relate to a system, wherein a depth of the laser-etch is in a range of 5 μm to 100 82 m.

In some aspects, the techniques described herein relate to a system, the system further including: a laser absorption plate below the transport path configured to absorb any of the plurality of beam segments that pass through the transport path.

In some aspects, the techniques described herein relate to a system, the system further including: a cover over a top portion of the transport path, wherein the plurality of objects are laser-etched below the cover, and wherein the cover couples with one or more fume covers that correspondingly surround the one or more laser windows.

In some aspects, the techniques described herein relate to a system, the system further including: a smoke extraction system configured to remove smoke and/or particulates from the system caused by the laser-etching.

In some aspects, the techniques described herein relate to a system, the system further including: a user interface configured to allow a user of the system to at least turn the laser system on, turn the laser system off, control the one or more beam deflectors, control a wattage produced by the laser source, control an etching depth of the plurality of beam segments, and/or activate and/or deactivate any of the one or more beam splitters.

In some aspects, the techniques described herein relate to a method for laser-etching a plurality of objects, the method including: transporting the plurality of objects from a first end to a second end of a transport path of a conveyor system, the conveyor system rotating about a first axis in a transporting direction; laser-etching the plurality of objects via a laser system, the laser system including: a laser source, the laser source emitting a laser beam; one or more beam splitters configured to split the laser beam into a plurality of beam segments; and one or more beam deflectors configured to direct each beam segment of the plurality of beam segments onto an outer surface of the plurality of objects, wherein each beam segment is configured to laser-etch the outer surface of the plurality of objects.

In some aspects, the techniques described herein relate to a method, further including: programming the laser system via a computer system, wherein instructions for the programming are uploaded to the laser system over a network.

In some aspects, the techniques described herein relate to a method, the method further including: extracting smoke and/or particulates generated from the laser-etching via a smoke extraction system.

In some aspects, the techniques described herein relate to a method, the method further including: controlling, via a user interface, the laser system, wherein controlling the laser system includes at least one of turning the laser system on, turning the laser system off, controlling the one or more beam deflectors, controlling a wattage produced by the laser source, controlling an etching depth of the plurality of beam segments, and/or activating and/or deactivating any of the one or more beam splitters.

In some aspects, the techniques described herein relate to a method, wherein the one or more beam deflectors are galvanometers.

In some aspects, the techniques described herein relate to a method, wherein a first beam splitter of the one or more beam splitters splits the laser beam into three transition beam segments, and wherein a second, a third, and a fourth beam splitter of the one or more beam splitters each split one of the three transition beam segments into four final beam segments.

In some aspects, the techniques described herein relate to a system for laser-etching a plurality of objects, the system including: a laser system configured to interact with the plurality of objects, the laser system including: a laser source, the laser source emitting a laser beam; one or more beam splitters configured to split the laser beam into a plurality of beam segments; and one or more beam deflectors configured to direct each beam segment of the plurality of beam segments onto an outer surface of the plurality of objects, wherein each beam segment is configured to laser-etch the outer surface of the plurality of objects; a smoke extraction system configured to remove smoke and/or particulates from the system caused by the laser-etching; and a computer system, wherein the computer system provides instructions to the laser system.

In some aspects, the techniques described herein relate to a system, the system further including: a conveyor system with a transport path that transports the plurality of objects from a first end to a second end, the conveyor system rotating about a first axis in a transporting direction, wherein the laser system is above the transport path and between the first end and the second end.

In some aspects, the techniques described herein relate to a system, wherein a depth of the laser-etch is in a range of 100 μm to 500 μm.

In some aspects, the techniques described herein relate to a system, wherein the one or more beam deflectors are galvanometers.

In some aspects, the techniques described herein relate to a system, the system further including: a user interface configured to allow a user of the system to at least turn the laser system on, turn the laser system off, control the one or more beam deflectors, control a wattage produced by the laser source, control an etching depth of the plurality of beam segments, and/or activate and/or deactivate any of the one or more beam splitters.

In some aspects, the techniques described herein relate to a system, further including: a cover over a top portion of the transport path, wherein the plurality of objects are laser-etched below the cover, wherein the smoke extraction system is connected to the cover.

In some aspects, the techniques described herein relate to a system, wherein the system is configured to laser-etch at a rate of 750,000 objects per hour.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of a portion of a laser-etching system according to aspects of the present disclosure.

FIG. 2A is a perspective view of a portion of a laser-etching system according to aspects of the present disclosure.

FIG. 2B is a detail view of Detail IIB in FIG. 2A.

FIG. 3 illustrates an implementation of a computer system that executes techniques of a laser-etching system according to aspects of the present disclosure.

FIG. 4 is a flow chart according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value.

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them. As used in the present disclosure, the singular forms “a,” “an” and “the” include plural referents unless the context clearly dictates otherwise.

References to “embodiment,” “an embodiment,” “one embodiment,” “in various embodiments,” “certain embodiments,” “some embodiments,” “other embodiments,” “certain other embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

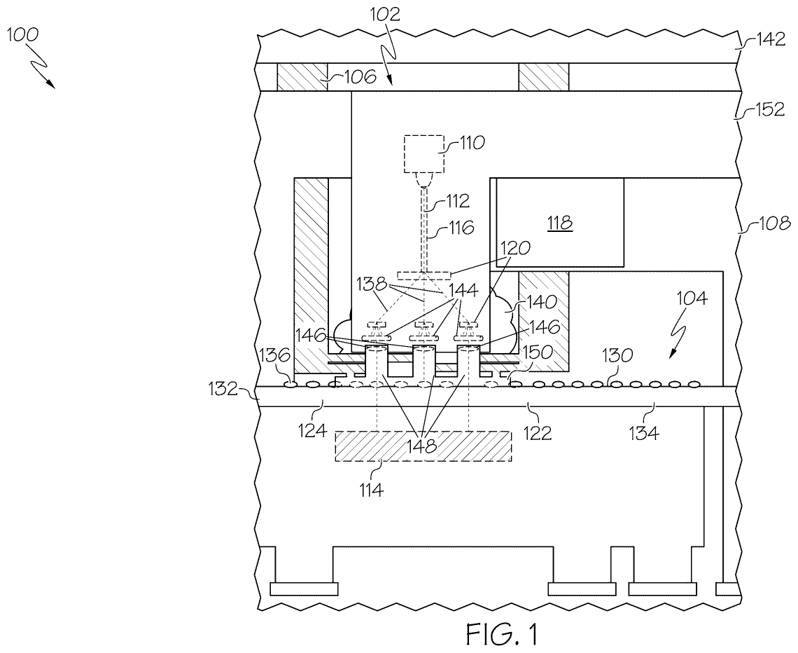

FIG. 1 is a side view of a portion of a laser-etching system according to aspects of the present disclosure. Laser-etching system 100 may include a laser system 102, a conveyor system 104, a smoke extraction system 106, a support structure 108, a laser absorption plate 114, a user interface 118, one or more fume covers 148, and a cover 150. Support structure 108 may house and/or support laser-etching system 100. Support structure 108 may be made of any suitable material capable of providing laser-etching system 100 with a durable, strong structure such as any combination of steel, aluminum alloy, cast iron, titanium, etc.

Conveyor system 104 may further include carrier bars 124 and a transport path 130 with a first end 132 and a second end 134. Conveyor system 104 may be configured to transport a plurality of product 136 from first end 132 to second end 134 via transport path 130. For example, an inlet may provide plurality of product 136 to the first end 132 of transport path 130 and an outlet may be at the second end 134 of transport path 130 to facilitate collection of plurality of product 136 after being laser-etched. As described herein, plurality of product 136 may be any type of product suitable for laser-etching. Preferably, plurality of product 136 is edible product (e.g., confectionary product) produced for consumers. For example, plurality of product 136 may be a chocolate product, a sweet product, a sugary product, etc. Plurality of product 136 may also be any shape or size. In an aspect, plurality of product 136 is small and has a substantially circular cross-section. In another aspect, plurality of product 136 is large and has a substantially oval cross-section. In yet another aspect, plurality of product 136 is both small and large with several cross-sections including rectangular, circular, and other non-uniform geometric shapes.

Laser system 102 may provide laser beams directly above transport path 130 to laser-etch outer surfaces of a plurality of product 136 (e.g., objects). Specifically, as seen in FIG. 1, laser system 102 may include a laser source 110, a laser tube 116, one or more beam splitters 120, one or more beam deflectors 144, and one or more laser windows 146. Laser source 110 may emit (e.g., generate, produce, etc.) laser beam 112. Additionally, laser source 110 may direct laser beam 112 towards one or more beam splitters 120. Laser tube 116 may surround laser beam 112 between laser source 110 and one or more beam splitters 120. One or more beam splitters 120 then split laser beam 112 into one or more beam segments 138. One or more beam deflectors 144 may then interact with the one or more beam segments 138 to deflect the one or more beam segments 138 through one or more laser windows 146 and onto the outer surfaces of plurality of product 136. While only one laser source generating one laser beam is shown, it is contemplated in the present disclosure that laser-etching system 100 includes more than one laser source. Each laser source may produce only one laser beam, or each laser source may produce more than one laser beam. As such, any combination of laser sources and laser beams may be used for laser system 102. In an example, the power of laser source 110 may be 1000 Watts.

One or more beam splitters 120 may be provided in succession to split laser beam 112 multiple times. As seen in FIG. 1, one of the one or more beam splitters 120 first splits laser beam 112 into three separate beam segments. Three of the one or more beam splitters 120 are then provided in a second group. Each of the three of the one or more beam splitters 120 further splits one of the three separate beam segments into four new beam segments. Thus, in this embodiment, laser beam 112 is split into a total of 12 beam segments. This example is meant to be illustrative and not limiting. For example, it is contemplated laser beam 112 is split into any number of one or more beam segments 138. Additionally, one or more beam splitters 120 may be provided in more than two groups. As an example, the first beam splitter may split a laser beam into two beam segments, a second group of two beam splitters may split each beam segment into two more beam segments, and a third group of beam splitters may split each beam segment into two more beam segments. In this example, the laser beam is split into a total of eight beam segments.

After laser beam 112 is split into all of its one or more beam segments 138 by the one or more beam splitters 120, one or more beam deflectors 144 may direct the one or more beam segments 138 appropriately. In the example illustrated by FIG. 1, there are three beam deflectors 144. Each of the three beam deflectors 144 direct four separate beam segments of the one or more beam segments 138.

In an example, one or more beam deflectors 144 are provided in succession. In this example, a laser beam is split into two beam segments by a first beam splitter. One of the two beam segments is then split into two more beam segments by a second beam splitter. The other beam segment, however, interacts with a first beam deflector and is directed towards the outer surface of the product. Similarly, one of the two beam segments created by the second beam splitter is split into two more beam segments by a third beam splitter while the other beam segment interacts with a second beam deflector and is directed towards the outer surface of the product. This can repeat as may be necessary for the system it is implemented in.

Each of the three beam deflectors 144 have corresponding laser windows 146. The three laser windows 146 are encased by corresponding fume covers 148 that couple to cover 150 as will be further described below. Thus, four beam segments of the one or more beam segments 138 are directed, via corresponding beam deflectors 144, through each laser window of the one or more laser windows 146 to the plurality of product 136.

Laser windows 146 may be provided directly above a portion of transport path 130. For example, transport path 130 may be much wider than one of the laser windows 146. In an example, one laser window is provided over one-third of the width of the transport path closest to one side, one laser window is provided over one-third of the width of the transport path closest to the other side, and one laser window is provided over one-third of the width of the transport path in the middle of the transport path between the other two laser windows. In this way, each laser window is configured to expose a different section of the plurality of product 136 on transport path 130 for the one or more beam segments 138 to laser-etch. At the very least, each product of the plurality of product 136 is exposed to one beam segment.

Additionally, laser windows 146 may slightly overlap and be staggered, e.g., laser windows 146 are provided one after another and over substantially different portions of the width of the transport path 130. However, each product of the plurality of product 136 may be exposed to more than one laser window. In other words, the portions of transport path 130 that each laser window exposes may partially overlap. This allows for better accuracy since at least a portion of the product is exposed to two separate groups of one or more beam segments 138, allowing the laser system 102 to potentially correct product that was not laser-etched. In an aspect, numerous laser windows are provided so each product on the transport path passes under more than one group of beam segments. In an example, each product on the transport path is exposed to more than one beam segment. The laser system may be capable of determining if product has been laser-etched or not such that the laser system does not laser-etch product that already has been.

Laser beam 112 (and one or more beam segments 138) may be configured to ablate the outer surface of the product supplied to laser-etching system 100. Laser system 102 may be capable of laser-etching letters, numbers, symbols, pictures, or any combination thereof. For example, laser system 102 may laser-etch a name (e.g., “Grant”) on each product. Laser system 102 may laser-etch one letter, e.g. “M”. Laser system 102 may laser-etch a flower onto the product. Laser system 102 may laser-etch “12” onto the product. Laser system 102 may be configured to laser-etch different product passing on the transport path with different laser-etching. For example, some of plurality of product 136 may be laser-etched with an Easter egg, some of plurality of product 136 may be laser-etched with a “T”, some of plurality of product 136 may be laser-etched with a “2”, and some of plurality of product 136 may be laser-etched with a “!”.

One or more beam splitters 120 may be any device known in the art such as plate beam splitters, cube beam splitters, polarizing beam splitters, dichroic beam splitters, or any combination thereof. Preferably, the one or more beam splitters of laser system 102 split the laser beams into beam segments of the same (or nearly the same) strength. One or more beam deflectors 144 may be any device known in the art, such as one or more galvanometers. In case of an emergency and/or an errant laser beam segment, laser absorption plate 114 may be provided below conveyor system 104 (e.g., below the transport path 130 where laser system 102 laser-etches plurality of product 136). For example, if one or more beam segments 138 misfire when no product is present and/or misses product, to protect the rest of laser-etching system 100 from potential damage, laser absorption plate 114 is configured to absorb the one or more beam segments 138. Laser absorption plate 114 is made of any suitable material capable of absorbing the laser beam segments generated by laser system 102.

Laser system 102 may be entirely or partially housed in a housing 152 held up by support structure 108 above conveyor system 104. One or more fume covers 148 may couple to cover 150. One or more fume covers 148 may be received by one or more corresponding openings in cover 150. Thus, one or more beam segments 138 may be substantially or entirely surrounded such that by-products caused by laser-etching do not propagate into the surrounding environment. Smoke extraction system 106 may then be connected to one or more fume covers 148 and/or cover 150 to assist in removing by-products from laser-etching system 100. Because laser-etching the product may create fumes, smoke, particulates, and other potentially hazardous by-products 140, laser-etching system 100 may have a smoke extraction system 106 that can extract (e.g., remove) the hazardous by-products 140 from laser-etching system 100. In the example shown in FIG. 1, smoke extraction system 106 is made of pipes with a pump (e.g., vacuum) system to create an air flow within the pipes. Hazardous by-products 140 are extracted from laser-etching system 100, and, more specifically, a portion of transport path 130 where the laser-etching occurs (e.g., the portion of transport path 130 covered by cover 150) to outside environment 142 via smoke extraction system 106. Outside environment 142 may be an outside containment area, a filtration system, a fan, or any other suitable way to release hazardous by-products 140.

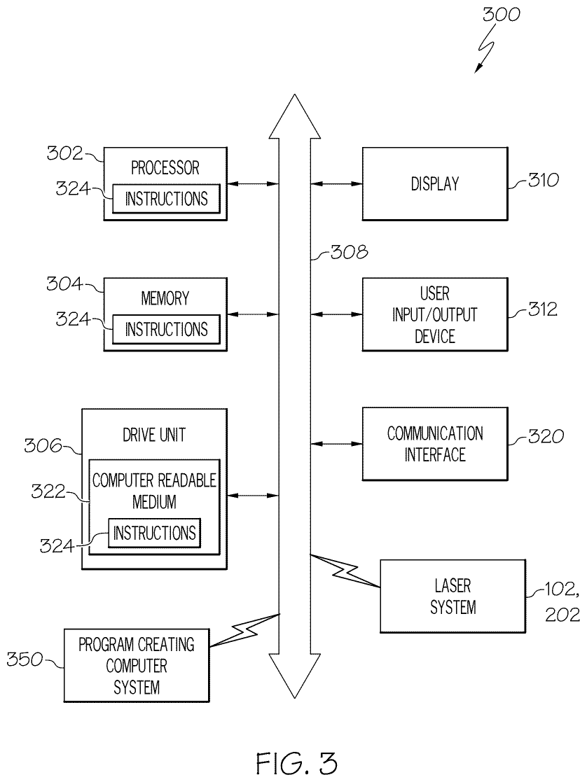

Laser system 102 may be powered by any way known in the art. For example, laser system 102 may be powered by electricity from various sources (e.g., fossil fuels, solar, wind, hydro, etc.). User interface 118 may allow a user of the laser-etching system 100 (or simply the laser system 102) to control laser system 102 as described with respect to FIG. 3.

Conveyor system 104 may facilitate the transportation process of the plurality of product 136. Conveyor system 104 may rotate about a first axis (e.g., the axis that is normal to the page in FIG. 1) in a transporting direction. For example, with respect to FIG. 1, conveyor system 104 may rotate clockwise about the first axis such that objects (e.g., product) are conveyed (e.g., transported) from left (e.g., first end 132) to right (e.g., second end 134). In this way, conveyor system 104 facilitates the movement of plurality of product 136 on transport path 130 from first end 132 to second end 134. Conveyor system 104 may be made up of carrier bars 124 such that the plurality of product 136 contact and are transported on carrier bars 124. Carrier bars 124 may be configured to better secure plurality of product 136 than conveyor system 104. In some aspects, carrier bars 124 may be provided over a conveyor belt 122 of conveyor system 104.

The conveyor system 104 (e.g., the outlet) may have a sorting function and/or include a device capable of performing a sorting function as described herein. After being laser-etched, plurality of product 136 may be sorted by separating whole products from partial or cracked products. Any broken pieces, partial pieces, cracked pieces, etc. of plurality of product 136 are separated from complete pieces of plurality of product 136. The incomplete pieces may then be thrown away or, if possible, recycled into new product. Conveyor system 104 may include this sorting function prior to laser-etching to remove the chance of a broken piece being laser-etched and after laser-etching. The sorting function may also include further sorting the complete plurality of product 136 between properly laser-etched and improperly laser-etched product. Again, the improperly laser-etched product may be thrown away or, if possible, recycled into new product. Thus, only complete, adequate product of the plurality of product 136 is produced by laser-etching system 100.

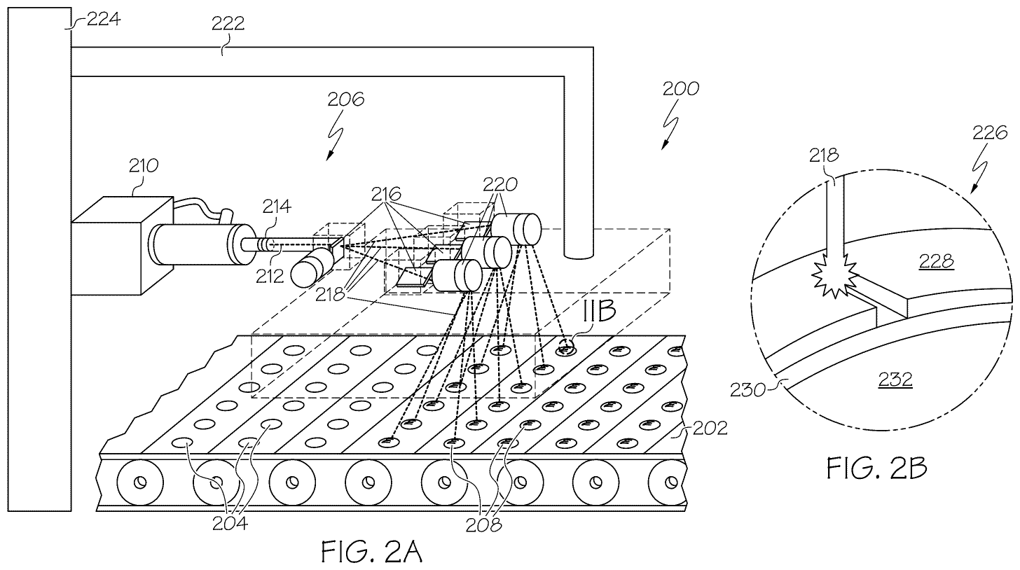

FIG. 2A is a perspective view of a portion of a laser-etching system according to aspects of the present disclosure. The components of laser-etching system 200 shown in FIG. 2A may perform similar functions as the components of laser-etching system 100. Laser-etching system 200 may include a conveyor system 202, unmarked product 204, laser system 206, marked product 208, smoke extraction system 222, and outside environment 224. Laser system 206 may further include laser source 210 that emits laser beam 212, laser tube 214, one or more beam splitters 216, one or more beam segments 218, and one or more beam deflectors 220.

Laser system 206 may have a housing (not shown) surrounding the components to protect the components from damage, wear, and/or interference. For example, laser system 206 may be within a housing so dust, dirt, etc. does not interfere with laser beam 212. Laser system 206 may be provided in one housing such that laser source 210, one or more beam splitters 216, and one or more beam deflectors 220 are all within the same walls or laser system 206 may be provided in multiple housings such that the components of laser system 206 are within separate walls. For example, laser source 210 may be in one housing while the remaining components (e.g., one or more beam splitters 216 and one or more beam deflectors 220) are in a separate housing. Thus, laser tube 214 may surround laser beam 212 as it leaves the housing with laser source 210 and enters the housing with one or more beam splitters 216 and one or more beam deflectors 220.

Conveyor system 202 may provide unmarked product 204 (e.g., product that has yet to be laser-etched by laser system 206) to laser system 206. Laser system 206 (e.g., the one or more beam segments 218) may then laser-etch the outer surface of the unmarked product 204. Thus, laser system 206 creates marked product 208 (e.g., product that has been laser-etched). Detail IIB illustrates how the beam segments of laser system 206 laser-etch the product.

FIG. 2B is a detail view of Detail IIB in FIG. 2A. Product 226 may be laser-etched by beam segment 218 at a depth D. As seen, product 226 may include an outer shell 228, an inner shell 230, and a core 232. One or more beam segments 218 may therefore be configured to ablate the entirety of outer shell 228, which corresponds to depth D. Laser system 206 (and laser system 102) may be programmed to laser-etch product to a certain depth D. Laser system 206 and laser system 102 may even be programmed to laser-etch product at varying depths depending on what design is being laser-etched. A user of laser-etching system 100 and/or laser-etching system 200 may be able to manually change/select depth D via user interface 118. Depth D may be in the range of 1 μm to 500 μm. Depth D may be 20 um. Depth D may be between 500 μm and 5,000 μm. Depth D may even be as large as 1 cm.

Product 226 may not include separate layers (e.g., outer shell 228, inner shell 230, and core 232) but instead may be made up of one, single region. However, it may be preferred to have product that includes at least two visually different regions. Since, when laser-etching, an outer portion (e.g., outer shell 228) of product 226 will be removed, an inner portion (e.g., inner shell 230) of product 226 will become exposed. The laser-etching performed may be much easier to see when viewing product 226 if outer shell 228 and inner shell 230 are different colors as it may provide further visual contrast.

FIG. 3 illustrates an implementation of a computer system that executes techniques of a laser-etching system according to aspects of the present disclosure. For example, user interface 118 may be the computer system 300. User interface 118 may include less components than shown in FIG. 3. As such, the components illustrated in computer system 300 are not meant to be limiting and/or required in the present disclosure as it will be appreciated by a person in the art. Additionally, while computer system 300 is illustrated as the computer system for laser system 102, laser system 102 may have a separate computer system. In this way, computer system 300 may remotely connect to laser-etching system 100, allowing a user to remotely control the laser system 102.

The computer system 300 may include a set of instructions that are executed to cause the laser-etching system 100 or laser-etching system 200 to perform certain functions. For example, computer system 300 may include instructions directed to laser system 102 (or laser system 206). In an example, computer system 300 is directly interacted with by a user to program the different components of laser-etching system 100. In an example, computer system 300 is preprogrammed and uploads the programs for the different components of laser-etching system 100 to run.

In this way, computer system 300 may be physically connected to a program creating computer system 350 configured to create the programs. The programs may be created on computer system 350 by any method known in the art. Computer system 350 may define the laser etch depth, the laser design, the laser intensity, etc. for a certain program. The program creating computer system 350 may provide the programs to computer system 300 via electrical wires. In an aspect, the programs created on program creating computer system 350 are uploaded to computer system 300 via a network. In an aspect, the programs created on program creating computer system 350 are supplied to computer system 300 via a flash drive. It is contemplated in the present disclosure that computer system 300 performs the functions of program creating computer system 350 instead of a separate computer system doing so. However, program creating computer system 350 may have the capabilities to run the software/hardware needed to program laser system 102 or laser system 206 while computer system 300 may not (e.g., computer system 300 may be a user interface computer system incapable of creating the laser programs for the laser system).

As illustrated in FIG. 3, the computer system 300 includes a processor 302, e.g., a central processing unit (CPU), a graphics processing unit (GPU), or both. The processor 302 is a component in a variety of systems. For example, the processor 302 is part of the laser system 102. The processor 302 is one or more processors, digital signal processors, application specific integrated circuits, field programmable gate arrays, servers, networks, digital circuits, analog circuits, combinations thereof, or other now known or later developed devices for analyzing and processing data. The processor 302 implements a program, such as code generated manually (e.g., programmed) or uploaded from program creating computer system 350.

The computer system 300 includes a memory 304 that communicates via bus 308. Memory 304 is a main memory, a static memory, or a dynamic memory. Memory 304 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. Memory 304 is an external storage device or database for storing data. Examples include a hard drive, flash drive, compact disc (CD), digital video disc (DVD), memory card, memory stick, floppy disc, universal serial bus (USB) memory device, or any other device operative to store data. The memory 304 is operable to store instructions executable by the processor 302. The functions, acts, or tasks illustrated in the figures or described herein are performed by processor 302 executing the instructions stored in memory 304. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 300 further includes a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 acts as an interface for the user to see the functioning of the processor 302, or specifically as an interface with the software stored in the memory 304 or in the drive unit 306.

Additionally or alternatively, the computer system 300 includes an input/output device 312 configured to allow a user to interact with any of the components of the computer system 300. The input/output device 312 is a number pad, a keyboard, a cursor control device, such as a mouse, a joystick, touch screen display, remote control, or any other device operative to interact with the computer system 300.

The computer system 300 also includes the drive unit 306 implemented as a disk or optical drive. The drive unit 306 includes a computer-readable medium 322 in which one or more sets of instructions 324, e.g. software, is embedded. Further, the sets of instructions 324 embodies one or more of the methods or logic as described herein. Instructions 324 resides completely or partially within memory 304 and/or within processor 302 during execution by the computer system 300. The memory 304 and the processor 302 also include computer-readable media as discussed above.

In some systems, computer-readable medium 322 includes the set of instructions 324 or receives and executes the set of instructions 324 responsive to a propagated signal so that laser system 102 and/or conveyor system 104 communicates data to computer system 300. Further, the sets of instructions 324 are transmitted or received via the communication port or interface 320, and/or using the bus 308. The communication port or interface 320 is a part of the processor 302 or is a separate component. The communication port or interface 320 is created in software or is a physical connection in hardware. The communication port or interface 320 is configured to connect with the laser system 102 and/or the conveyor system 104, display 310, or any other components in the computer system 300, or combinations thereof.

While the computer-readable medium 322 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 322 is non-transitory, and may be tangible.

The computer-readable medium 322 includes a solid-state memory such as a memory card or other package that houses one or more non-volatile read-only memories. The computer-readable medium 322 is a random-access memory or other volatile re-writable memory. Additionally or alternatively, the computer-readable medium 322 includes a magneto-optical or optical medium, such as a disk or tapes or other storage device to capture carrier wave signals such as a signal communicated over a transmission medium.

In an alternative implementation, dedicated hardware implementations, such as application specific integrated circuits (ASICs), programmable logic arrays, and other hardware devices, is constructed to implement one or more of the methods described herein. For example, laser system 102 may include an ASIC and conveyor system 104 may include a separate (or the same) ASIC. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Regardless of implementation (e.g., whether implemented via an ASIC, computer system 300, etc.), laser system 102 includes numerous programmable controls. For example, user interface 118 may turn laser system 102 on/off, control the one or more galvanometers, control the wattage produced by the laser source, control the amount of active beam splitters (to control how many beam segments are produced), control the penetration depth (e.g., rate of etching) of the laser, etc. Laser-etching system 100 may be programmed to produce (and capable of producing) laser-etched product at a maximum rate of 1,000,000 objects per hour. Laser-etching system 100 may be programmed to produce (and capable of producing) laser-etched product at a maximum rate of 500,000 objects per hour. Laser-etching system 100 may be programmed to produce (and capable of producing) laser-etched product at a maximum rate of 750,000 objects per hour. As should be appreciated, laser-etching system 100 can produce laser-etched product at any rate below its maximum rate. All of the described functions may be controlled by a singular user interface, such as computer system 300, an ASIC, or any combination of software, firmware, and hardware.

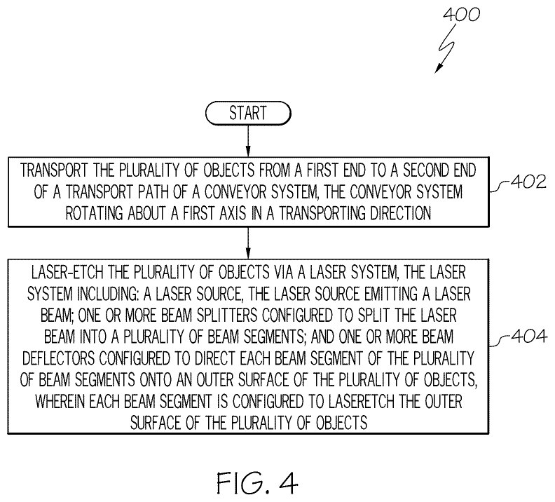

FIG. 4 is a flow chart 400 according to aspects of the present disclosure. Flow chart 400 may correspond to a method of laser-etching a plurality of objects. The method described by flow chart 400 may use components that have been previously described with respect to laser-etching system 100. Accordingly, the disclosure below uses the same reference labels as laser-etching system 100 when describing the various steps of flow chart 400, but flow chart 400 is not limited by the explicit components described in laser-etching system 100.

Step 402 may include transporting the plurality of objects (e.g., product 136) from a first end 132 to a second end 134 of a transport path 130 of a conveyor system 104, the conveyor system 104 rotating about a first axis in a transporting direction.

Step 404 may include laser-etching the plurality of objects 136 via a laser system 102. The laser system 102 may include a laser source 110 that emits a laser beam 112. The laser system 102 may also include one or more beam splitters 120 configured to split the laser beam 112 into a plurality of beam segments 138. The laser system may also include one or more beam deflectors 144 configured to direct each beam segment 138 onto an outer surface of the plurality of objects 136. Each beam segment 138 may be configured to laser-etch the outer surface of the plurality of objects 136. The one or more beam deflectors 144 may be galvanometers. A first beam splitter may split the laser beam 112 into three transition beam segments, and a second, a third, and a fourth beam splitter may each split one of the three transition beam segments into four final beam segments, thus providing 12 beam segments.

The method may also include programming the laser system 102 via a computer system 300 or 350 such that the program is uploaded to the laser system 102 over a network. The method may include extracting smoke and/or particulates generated from laser-etching via a smoke extraction system 106. The method may include controlling, via a user interface 118, the laser system 102. The controls provided to a user may include turning the laser system 102 on, turning the laser system 102 off, controlling the one or more beam deflectors 144, controlling a wattage produced by the laser source 110, controlling an etching depth D of the plurality of beam segments 138, and/or activating and/or deactivating any of the one or more beam splitters 120.

It will be apparent to those skilled in the art that modifications may be made in the disclosed systems and methods without departing from the scope of the disclosure. Other aspects of the disclosure will be apparent to those skilled in the art from consideration of the specification and practice of the features disclosed herein. It is intended that the specification and embodiments be considered as exemplary only.

What is claimed is:

1. A system for laser-etching a plurality of objects, the system comprising:
a conveyor system with a transport path that transports the plurality of objects from a first end to a second end, the conveyor system rotating about a first axis in a transporting direction; and
a laser system configured to interact with the plurality of objects while the plurality of objects are on the transport path between the first end and the second end, the laser system including:
a laser source, the laser source emitting a laser beam;
one or more beam splitters configured to split the laser beam into a plurality of beam segments; and
one or more beam deflectors configured to direct each beam segment of the plurality of beam segments onto an outer surface of the plurality of objects,
wherein each beam segment is configured to laser-etch the outer surface of the plurality of objects.

2. The system of claim 1, the laser system is within a housing, and wherein the one or more beam deflectors deflect the plurality of beam segments through one or more laser windows above the transport path.

3. The system of claim 1, wherein a depth of the laser-etch is in a range of 5 μm to 100 μm.

4. The system of claim 1, the system further comprising:
a laser absorption plate below the transport path configured to absorb any of the plurality of beam segments that pass through the transport path.

5. The system of claim 2, the system further comprising:
a cover over a top portion of the transport path, wherein the plurality of objects are laser-etched below the cover, and wherein the cover couples with one or more fume covers that correspondingly surround the one or more laser windows.

6. The system of claim 1, the system further comprising:
a smoke extraction system configured to remove smoke and/or particulates from the system caused by the laser-etching.

7. The system of claim 1, the system further comprising:
a user interface configured to allow a user of the system to at least turn the laser system on, turn the laser system off, control the one or more beam deflectors, control a wattage produced by the laser source, control an etching depth of the plurality of beam segments, and/or activate and/or deactivate any of the one or more beam splitters.

8. A method for laser-etching a plurality of objects, the method comprising:
transporting the plurality of objects from a first end to a second end of a transport path of a conveyor system, the conveyor system rotating about a first axis in a transporting direction;
laser-etching the plurality of objects via a laser system, the laser system including:
a laser source, the laser source emitting a laser beam;
one or more beam splitters configured to split the laser beam into a plurality of beam segments; and
one or more beam deflectors configured to direct each beam segment of the plurality of beam segments onto an outer surface of the plurality of objects,
wherein each beam segment is configured to laser-etch the outer surface of the plurality of objects.

9. The method of claim 8, further comprising:
programming the laser system via a computer system, wherein instructions for the programming are uploaded to the laser system over a network.

10. The method of claim 8, the method further comprising:
extracting smoke and/or particulates generated from the laser-etching via a smoke extraction system.

11. The method of claim 8, the method further comprising:
controlling, via a user interface, the laser system, wherein controlling the laser system includes at least one of turning the laser system on, turning the laser system off, controlling the one or more beam deflectors, controlling a wattage produced by the laser source, controlling an etching depth of the plurality of beam segments, and/or activating and/or deactivating any of the one or more beam splitters.

12. The method of claim 8, wherein the one or more beam deflectors are galvanometers.

13. The method of claim 8, wherein a first beam splitter of the one or more beam splitters splits the laser beam into three transition beam segments, and wherein a second, a third, and a fourth beam splitter of the one or more beam splitters each split one of the three transition beam segments into four final beam segments.

14. A system for laser-etching a plurality of objects, the system comprising:
a laser system configured to interact with the plurality of objects, the laser system including:
a laser source, the laser source emitting a laser beam;
one or more beam splitters configured to split the laser beam into a plurality of beam segments; and
one or more beam deflectors configured to direct each beam segment of the plurality of beam segments onto an outer surface of the plurality of objects, wherein each beam segment is configured to laser-etch the outer surface of the plurality of objects;
a smoke extraction system configured to remove smoke and/or particulates from the system caused by the laser-etching; and
a computer system, wherein the computer system provides instructions to the laser system.

15. The system of claim 14, the system further comprising:
a conveyor system with a transport path that transports the plurality of objects from a first end to a second end, the conveyor system rotating about a first axis in a transporting direction, wherein the laser system is above the transport path and between the first end and the second end.

16. The system of claim 14, wherein a depth of the laser-etch is in a range of 100 μm to 500 μm.

17. The system of claim 14, wherein the one or more beam deflectors are galvanometers.

18. The system of claim 17, the system further comprising:
a user interface configured to allow a user of the system to at least turn the laser system on, turn the laser system off, control the one or more beam deflectors, control a wattage produced by the laser source, control an etching depth of the plurality of beam segments, and/or activate and/or deactivate any of the one or more beam splitters.

19. The system of claim 15, further comprising:
a cover over a top portion of the transport path, wherein the plurality of objects are laser-etched below the cover, wherein the smoke extraction system is connected to the cover.

20. The system of claim 14, wherein the system is configured to laser-etch at a rate of 750,000 objects per hour.
